(19) United States
(12) Patent Application Publication
(10) Pub. No.: US 2023/0233975 A1
(43) Pub. Date: Jul. 27, 2023

(54) AEROSOL OR VAPOR TRAP FOR ELEMENTAL IMPURITIES EMISSION ANALYSIS OF HIGH VISCOSITY MATRICES USED IN NON-BURNING VAPORIZATION DEVICES

(71) Applicant: Nordic Analytical Laboratories LLC, Denver, CO (US)

(72) Inventors: Kimia Mahmoodi, Denver, CO (US); Aleksey Nikolayev, Denver, CO (US)

(73) Assignee: Nordic Analytical Laboratories LLC, Denver, CO (US)

(21) Appl. No.: 18/102,004

(22) Filed: Jan. 26, 2023

Related U.S. Application Data
(60) Provisional application No. 63/303,414, filed on Jan. 26, 2022.

(51) Int. Cl. B01D 46/30; A24F 42/90; B01D 46/00; B01J 20/10; B01J 20/24; B01J 20/28

(52) U.S. Cl. CPC B01D 46/30; A24F 42/90; B01D 46/0047; B01D 46/0036; B01J 20/10; B01J 20/24; B01J 20/28023

(57) ABSTRACT

Methods, apparatus, and systems for provision of an aerosol/vapor trap for elemental impurities emission analysis of high viscosity matrices used in non-burning vaporization devices are disclosed. In an embodiment, filter material filter material captures one or more elemental impurities from a non-burning vaporization device. A vessel contains the filter material. Other embodiments are also disclosed and claimed.

### RELATED APPLICATIONS

The present application claims priority from U.S. Provisional Patent Application, Ser. No. 63/303,414, filed Jan. 26, 2022, entitled “AEROSOL TRAP FOR ELEMENTAL IMPURITIES EMISSION ANALYSIS OF HIGH VISCOSITY MATRICES USED IN NON-BURNING VAPORIZATION DEVICES,” which is incorporated herein in its entirety and for all purposes.

### FIELD OF THE INVENTION

The present disclosure generally relates to the field of impurities emission analysis. More particularly, some embodiments relate to an aerosol/vapor trap for elemental impurities emission analysis in non-burning vaporization devices.

### BACKGROUND OF THE INVENTION

Vaporizing devices are currently marketed as a safer/healthier alternative to smoking. In order to safeguard consumers' health, vaping devices and materials they deliver are generally required to undergo a rigorous testing regimen for doze delivery and possible presence of contaminants, e.g., organic and elemental. However, vaporizer devices operate differently from cigarettes and require new techniques for testing.

### BRIEF DESCRIPTION OF DRAWINGS

The detailed description is provided with reference to the accompanying figure(s).

In the figures, the left-most digit(s) of a reference number identifies the figure in which the reference number first appears. The use of the same reference numbers in different figures indicates similar or identical items.

FIG. 1 illustrates a sample filter design, according to an embodiment.

### DETAILED DESCRIPTION OF THE INVENTION

Most current testing techniques have been developed for cigarettes. Cigarettes emit submicron particles during burning. Those can be deposited on flat filters/impingers and they are readily deposited using electrostatic charge.

One big challenge is a much bigger spectrum of liquids used for non-burning evaporation with characteristic boiling points and/or viscosity, as well as viscosity change with temperature. Common types of traps like impingers, electrostatic traps, and different types of flat filters used for cigarettes fail to capture sufficient representative samples of the vaped material and become clogged, e.g., allowing some of the puff (or exhaust gases) to escape, e.g., causing cross-contamination, which may lead to unstable testing conditions (such as change of flow rates/pressure drop), for example, requiring multiple washes and cleanings leading to loss of sensitivity and/or efficiency.

Further, it is common to test electronic cigarette (e-cigarette) devices using CORESTA™ (Cooperation Centre for Scientific Research Relative to Tobacco) recommended method 81, which recommends two puffs per minute, each puff 3-5 seconds, with a flow rate of approximately 15 ml/sec which generates volumes of approximately 45 to 120 milli liter (ml) per puff. However, this approach would generate a load for the trap which cannot be handled with existing types of filters.

Some embodiments provide an aerosol/vapor trap for elemental impurities emission analysis of high viscosity matrices used in non-burning vaporization devices. An embodiment allows for the capture of the full volume of the puff generated by a vaporizing device imitating the capacity of the human upper respiratory volume (e.g., approximately 50 to 150 ml), for example, by depositing the full volume of the puff immediately on a sufficient amount of the filter material.

In an embodiment, the trap catches the product of non-burning vaporization of (e.g., heavy) matrices such as cannabis oils, hemp oils, with or without liquid fillers, etc. Such techniques may be utilized in testing emissions from evaporation devices. In at least one embodiment, a direct capturing filter design is provided which utilizes a tube fitted at the outlet of a vaporization device filled with fibrous material. In various embodiments, the fibrous material includes one or more of: glass, quart, cotton, artificial cotton-like material, or combinations thereof. The fibrous material with captured deposits may then be used directly in elemental analysis (such as analysis for inorganic components like heavy metals, through digestion for inductively coupled plasma mass spectroscopy and/or optical emissions spectroscopy).

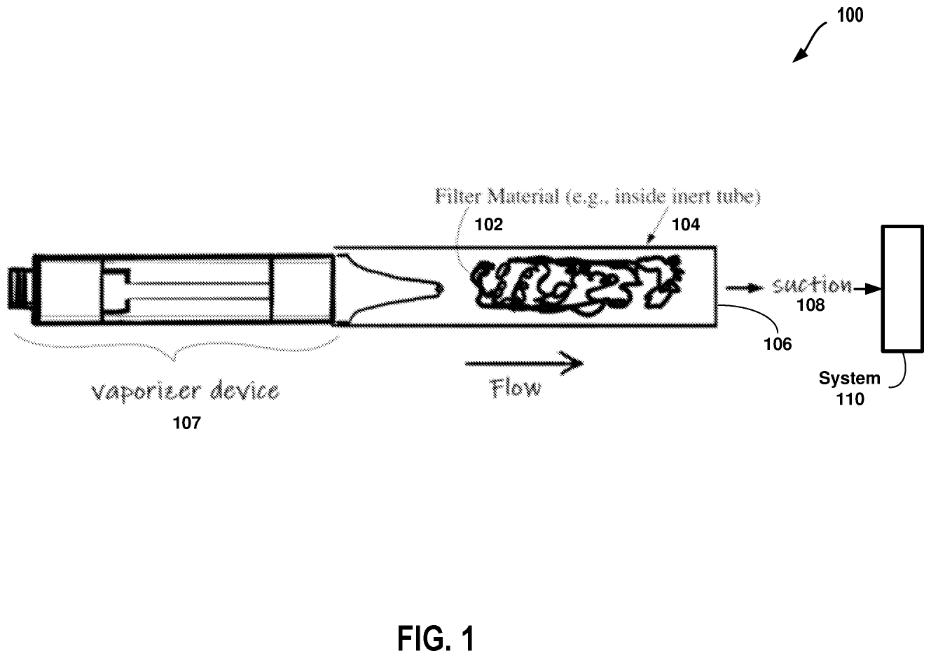

FIG. 1 illustrates a sample filter design 100, according to an embodiment. As shown, filter material 102 may be contained in an inert tube 104, e.g., fitted to the output 106 of a vaporizer device 107. Suction 108 is provided at the back of the tub containing the filter (on the right side of FIG. 1 as labeled). A filter trap (formed by the tube 104 housing the filter material 102) is fitted between the emission end 106 of the vaporization device 107 and a system 110 providing the flow/suction 108.

In one embodiment, the filter trap is made of a chemically inert vessel (e.g., 104) filled with a fibrous material (e.g., 102). The fibrous filling may include one or more of glass wool, quartz glass wool, paper, natural or synthetic cotton fibers, etc. Dimensions of the tube 104 may be matched to the dimensions of the vaporizer device 107 exhaust snuggly/tightly (to reduce or eliminate any leakage). The filtering material may be in sufficient amount to accommodate full capture, e.g., anywhere from 20 mm to 100 mm in one or more embodiments. The amount of the filter material may be adjusted to sufficiently absorb evaporated material. The absorbent material may then be removed from the tube 104 and used (e.g., in its entirety) in subsequent elemental analysis. One distinguishing property of at least one embodiment is that it provides an advantage for capturing large amounts of aerosols/vapors which are characteristic of non-burn vaporizer devices, e.g., without affecting the quality of the flow from clogging.

In an embodiment, a device includes a cylindrical vessel, filled with a filter material, through which realistic puffs are being delivered using a negative pressure on the filter. The packing of the filter material and/or the negative pressure on the emissions apparatus may be optimized to catch the aerosols present in the emissions without disrupting (or with little disruption to) the emissions flow.

In one embodiment, the cylindrical vessel contains a mixture of different fibrous materials selected for collecting a specific (e.g., possibly) volatile matrix (e.g., where a volatile matrix can only be captured/detected for a limited time, such as in seconds, milli seconds, etc.). In another embodiment, the filter fibrous material is impregnated with an oxidizing or reducing media, to add chemical binding property to physical absorption/adsorption. In some embodiments, the aerosol trapping device is capable of trapping/capturing the aerosol of various nature directly and used in further elemental impurities analysis directly, through continuous or pulsed sorption. As discussed herein, “sorption” generally refers to a process of fixation or capture of a gas or a vapor (sorbate) by a substance in condensed state (solid or liquid) called sorbent (e.g., filter material 102).

The following examples pertain to further embodiments. Example 1 includes an apparatus comprising: filter material to capture one or more elemental impurities from a non-burning vaporization device; and a vessel to contain the filter material, wherein the vessel is to be coupled to an exhaust of the non-burning vaporization device to capture the one or more elemental impurities. Example 2 includes the apparatus of example 1, wherein the filter material is to capture the one or more elemental impurities from a vapor or aerosol exhaust of the non-burning vaporization device. Example 3 includes the apparatus of example 1, wherein the captured one or more elemental impurities are to be to be applied in emission analysis of high viscosity matrices. Example 4 includes the apparatus of example 1, wherein the filter material is capable to capture approximately 50 to 150 milli liter (ml).

Example 5 includes the apparatus of example 1, wherein the filter material comprises fibrous material. Example 6 includes the apparatus of example 1, wherein the vessel comprises an inert tube. Example 7 includes the apparatus of example 6, wherein the vessel comprises a cylindrical tube. Example 8 includes the apparatus of example 1, wherein the filter material is to capture a product of non-burning vaporization of one or more matrices. Example 9 includes the apparatus of example 8, wherein the one or more matrices comprise one or more of: cannabis oil with one or more liquid fillers, hemp oil with one or more liquid fillers, cannabis oil without a liquid filler, and hemp oil without a liquid filler.

Example 10 includes the apparatus of example 1, wherein the vessel is to be tightly coupled to the exhaust of the non-burning vaporization device to reduce or eliminate leakage of exhaust vapor or aerosol emissions from the non-burning vaporization device. Example 11 includes the apparatus of example 1, wherein the vessel is to be tightly coupled to the exhaust of the non-burning vaporization device to capture all vapor or aerosol emissions from the non-burning vaporization device. Example 12 includes the apparatus of example 1, wherein the filter material comprises one or more of: glass wool, quartz glass wool, paper, and natural or synthetic cotton fibers. Example 13 includes the apparatus of example 1, wherein packing of the filter material or a negative pressure on emissions from the non-burning vaporization device is to avoid or reduce disruption to flow of the emissions. Example 14 includes the apparatus of example 1, wherein at least one of the one or more elemental impurities comprises a volatile matrix. Example 15 includes the apparatus of example 1, wherein the filter material is to be impregnated with an oxidizing or reducing media.

Example 16 includes a system comprising: a trap including: filter material to capture one or more elemental impurities from a non-burning vaporization device; and a vessel to contain the filter material, wherein the vessel is to be coupled to an exhaust of the non-burning vaporization device to capture the one or more elemental impurities; and a suction device to generate a flow of the one or more elemental impurities from the non-burning vaporization device through the filter material. Example 17 includes the system of example 16, wherein the suction device is to be tightly coupled to an opposing end of the vessel from an end of the vessel that is to couple to the non-burning vaporization device. Example 18 includes the system of example 16, wherein the suction device is to generate the flow as a continuous and/or pulsed flow. Example 19 includes the system of example 16, wherein the filter material comprises one or more of: glass wool, quartz glass wool, paper, and natural or synthetic cotton fibers. Example 20 includes the system of example 16, wherein the vessel comprises an inert tube.

Example 21 includes an apparatus comprising means to perform a method as set forth in any preceding example.

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
filter material to capture one or more elemental impurities from a non-burning vaporization device; and
a vessel to contain the filter material,
wherein the vessel is to be coupled to an exhaust of the non-burning vaporization device to capture the one or more elemental impurities.

2. The apparatus of claim 1, wherein the filter material is to capture the one or more elemental impurities from a vapor or aerosol exhaust of the non-burning vaporization device.

3. The apparatus of claim 1, wherein the captured one or more elemental impurities are to be to be applied in emission analysis of high viscosity matrices.

4. The apparatus of claim 1, wherein the filter material is capable to capture approximately 50 to 150 milli liter (ml).

5. The apparatus of claim 1, wherein the filter material comprises fibrous material.

6. The apparatus of claim 1, wherein the vessel comprises an inert tube.

7. The apparatus of claim 6, wherein the vessel comprises a cylindrical tube.

8. The apparatus of claim 1, wherein the filter material is to capture a product of non-burning vaporization of one or more matrices.

9. The apparatus of claim 8, wherein the one or more matrices comprise one or more of: cannabis oil with one or more liquid fillers, hemp oil with one or more liquid fillers, cannabis oil without a liquid filler, and hemp oil without a liquid filler.

10. The apparatus of claim 1, wherein the vessel is to be tightly coupled to the exhaust of the non-burning vaporization device to reduce or eliminate leakage of exhaust vapor or aerosol emissions from the non-burning vaporization device.

11. The apparatus of claim 1, wherein the vessel is to be tightly coupled to the exhaust of the non-burning vaporization device to capture all vapor or aerosol emissions from the non-burning vaporization device.

12. The apparatus of claim 1, wherein the filter material comprises one or more of: glass wool, quartz glass wool, paper, and natural or synthetic cotton fibers.

13. The apparatus of claim 1, wherein packing of the filter material or a negative pressure on emissions from the non-burning vaporization device is to avoid or reduce disruption to flow of the emissions.

14. The apparatus of claim 1, wherein at least one of the one or more elemental impurities comprises a volatile matrix.

15. The apparatus of claim 1, wherein the filter material is to be impregnated with an oxidizing or reducing media.

16. A system comprising:
a trap including:
filter material to capture one or more elemental impurities from a non-burning vaporization device; and
a vessel to contain the filter material, wherein the vessel is to be coupled to an exhaust of the non-burning vaporization device to capture the one or more elemental impurities; and
a suction device to generate a flow of the one or more elemental impurities from the non-burning vaporization device through the filter material.

17. The system of claim 16, wherein the suction device is to be tightly coupled to an opposing end of the vessel from an end of the vessel that is to couple to the non-burning vaporization device.

18. The system of claim 16, wherein the suction device is to generate the flow as a continuous and/or pulsed flow.

19. The system of claim 16, wherein the filter material comprises one or more of: glass wool, quartz glass wool, paper, and natural or synthetic cotton fibers.

20. The system of claim 16, wherein the vessel comprises an inert tube.
